(19) United States
(12) Patent Application Publication
(10) Pub. No.: US 2005/0191983 A1
(43) Pub. Date: Sep. 1, 2005

(54) Receiving arrangement for a radio signal

(76) Inventor: Heiko Korner, Soding (AT)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/042,948

(22) Filed: Jan. 25, 2005

Related U.S. Application Data
(63) Continuation of application No. PCT/DE03/02469, filed on Jul. 22, 2003.

(30) Foreign Application Priority Data
Jul. 25, 2002 (DE) DE 102 33 909.0

(51) Int. Cl. H04B 1/18; H04B 1/16; H04Q 7/20

(52) U.S. Cl. 455/280; 455/334

(57) ABSTRACT

A receiving arrangement for a radio signal includes a step-down mixer with a downstream signal processing chain and demodulator. An RSSI signal is obtained between the step-down mixer and the demodulator, for example in a limiter. The RSSI signal is high-pass filtered and supplied to a comparator in the form of a mean value thereof. The identification unit can detect as a function of the RSSI signal level whether no useful signal at all, an amplitude-modulated signal or a frequency-modulated signal is present. The demodulator is accordingly driven by a control unit. In accordance with the arrangement of the present invention it is possible, in a particularly simple and precise manner, to identify and correspondingly set a demodulator as a function of whether an amplitude-modulated or frequency-modulated signal is received.

### REFERENCE TO RELATED APPLICATION

This application is a continuation of PCT/DE03/02469, which was not published in English, that claims the benefit of the priority date of German Patent Application No. DE 102 33 909.0, filed on Jul. 25, 2002, the contents of which are herein incorporated by reference in their entirety.

### FIELD OF THE INVENTION

The present invention relates to a receiving arrangement for a radio signal.

### BACKGROUND OF THE INVENTION

Both phase or frequency modulation methods and amplitude modulation methods, as well as combinations of the two, are customary in modern mobile radio which operates using digital modulation.

It is therefore desirable to build radio receivers which can be used universally and handle different types of modulation. However, the problem with multisystem receivers such as these is that the demodulator must know the type of modulation in order to be able to demodulate a received signal correctly. To this end, it is desirable to identify, as early as possible in the signal processing chain, the modulation method used to modulate a received radio-frequency signal.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

The present invention is directed to a receiving arrangement for a radio signal, which is designed for at least two different types of modulation and makes it possible to identify, with little complexity and relatively quickly, the modulation method used to modulate a radio signal.

According to the invention, the receiving arrangement of the present invention comprises a step-down frequency converter having a first input for injecting the radio signal, a second input for supplying a local oscillator signal, and an output. The arrangement also comprises an amplifier having an amplifier input, which is coupled to the output of the step-down frequency converter, an amplifier output, and an output for emitting a received field strength signal. A demodulator is also included and operates to demodulate a signal which has been down-mixed and amplified, wherein the demodulator includes a signal input, which is connected to the amplifier output, a signal output for emitting a demodulated signal, and a control input for preselecting a demodulation method from a number of predetermined demodulation methods. Further, the arrangement comprises an identification unit having a high-pass filter, which has an input that is connected to the output of the amplifier that emits a received field strength signal, and a threshold value comparator whose input is coupled to the output of the high-pass filter and whose output is coupled to the control input of the demodulator. The identification unit is configured to emit a value that represents the radio signal's modulation method.

The amplifier may have a gain factor of 1.

In accordance with the present invention, the received field strength signal is analyzed in order to detect the modulation method used to modulate a received radio signal.

The received field strength signal is normally also referred to as a receive signal strength indicator (RSSI) signal. In accordance with the present invention, the RSSI signal which is normally provided by the received signal chain is used to distinguish, in a simple manner, between amplitude-modulated signals and frequency-modulated and/or phase-modulated signals.

It is thus possible, for example, to distinguish between signals which have been modulated using amplitude shift keying (ASK) and frequency-shift-keyed (FSK) signals.

In addition to the exemplary distinction between ASK and FSK, the present invention may also be used to detect any other modulation method which has been developed further and is based on phase or amplitude modulation.

In accordance with the present invention, the DC component of the RSSI signal is first of all suppressed, and only the alternating current component of the RSSI signal is evaluated.

The DC component of an RSSI signal is normally used to measure the instantaneous field strength. Depending on the mobile radio standard used, the transmission power of the respective mobile radio, for example, is set as a function of the measured field strength.

Alternatively or in addition, the measurement signal may be transmitted to the base station in order to determine the transmission power of the latter in an adaptive control system.

If no radio signal is received at all, the alternating component of the RSSI signal has a specific magnitude which is determined by the receiving architecture, the radio channel and the noise characteristics. The conditioned RSSI signal at the input of the threshold value comparator increases when an amplitude-modulated signal is received, since the signal power increases as a result of the fluctuations in amplitude. However, when a signal of constant amplitude is received, as is the case with frequency-modulated or phase-modulated signals, the filtered RSSI signal value becomes smaller and tends toward zero for higher field strengths.

Overall, evaluating the RSSI signal in accordance with the present invention accordingly makes it possible to determine, in a particularly simple and rapid manner, how a received radio signal has been modulated and/or whether a useful signal is received at all.

One particular advantage results from the fact that the DC component of the RSSI signal is usually evaluated in radio receivers anyway in order to determine the received field strength.

The present method makes it possible to actually determine whether there is a signal in the reception channel and, instead or in addition, to decide whether a received radio signal has been phase-modulated, frequency-modulated or amplitude-modulated.

The received field strength signal is preferably provided at an output of a limiting amplifier, a so-called limiter, which is connected downstream of the step-down frequency converter.

The AC component of the RSSI signal, which is obtained using the high-pass filter, is preferably processed in the identification unit by forming the mean value, the root mean square value or the mean magnitude.

In this case, the spectrum of the RSSI signal is not be trimmed too severely in advance.

The threshold value comparator preferably evaluates the conditioned RSSI signal with respect to one or two threshold values and, by comparing the conditioned RSSI signal with the threshold values, determines whether no signal at all, an amplitude-modulated signal or only a phase-modulated or frequency-modulated signal is present.

In the case of a frequency-modulated signal, the present invention in this case detects whether the signal has a constant envelope.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

The invention is explained in more detail below using an exemplary embodiment and with reference to the drawings, in which:

FIG. 1 is a block diagram illustrating an exemplary receiving arrangement with RSSI signal evaluation in accordance with the present invention,

FIG. 2 is a graph illustrating a comparison of an RSSI signal in the case of amplitude modulation with an RSSI signal in the case of frequency modulation,

FIG. 3 is a combined block/schematic diagram illustrating one exemplary embodiment of the identification unit, such as that illustrated in FIG. 1, which evaluates the RSSI signal,

FIG. 4 is a graph illustrating exemplary signal profiles of selected signals in the case of frequency modulation, and

FIG. 5 is a graph illustrating exemplary signal profiles of selected signals in the case of amplitude modulation.

### DETAILED DESCRIPTION OF THE INVENTION

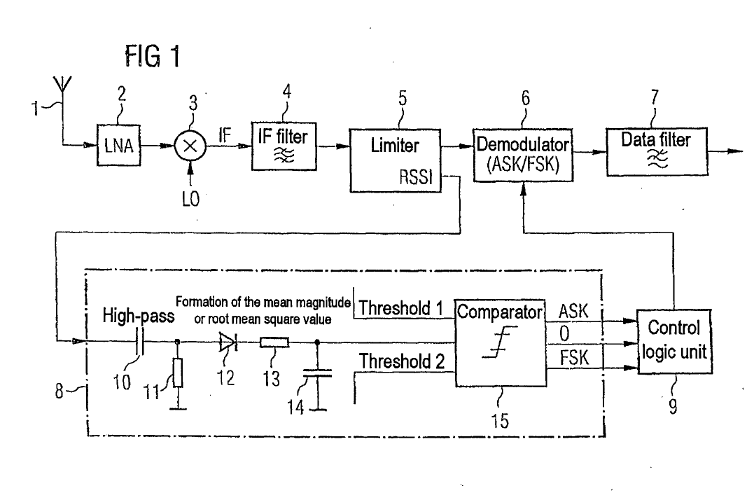

FIG. 1 uses a block diagram illustrating a radio receiver arrangement in accordance with an exemplary embodiment of the present invention. A low-noise preamplifier 2 which is connected to a first input of a step-down frequency mixer 3 is coupled to a receiving antenna 1. The second connection of the step-down frequency mixer 3 is connected to a frequency generator (not shown) which provides a local oscillator signal at the received signal's carrier frequency. An intermediate frequency signal at an intermediate frequency level IF is produced at the output of the frequency mixer 3, said signal being filtered in a downstream bandpass filter 4. A limiting amplifier 5, a so-called limiter, which has a plurality of stages is connected to the output of the intermediate frequency filter 4. The output of said limiter 5 is connected to the input of a demodulator 6 which is designed to allow selection of amplitude shift keying and frequency shift keying. A further filter 7 is connected to the demodulator output of the demodulator 6.

The limiter 5 has a further output at which a received field strength signal, a so-called RSSI (receive signal strength indicator) signal, is produced. The RSSI output of the limiter 5 is connected to an identification unit 8 which drives a control unit 9 (whose output is connected to a control input for preselecting a demodulation method at the demodulator 6) as a function of radio-frequency signal components of the RSSI signal.

On the input side, the identification unit 8 comprises a high-pass filter 10, 11 having a series capacitance 10 and a resistor 11 which is connected to ground. A root mean square value determining circuit 12, 13, 14, which comprises a forward-biased diode 12 and a resistor 13 (which is connected in series with the latter) with a downstream capacitor 14 that is connected to ground, is connected to the high-pass filter 10, 11. An RSSI signal which has been high-pass filtered and averaged is accordingly produced at the output of the root mean square value forming device, said signal being fed to an input of a threshold value comparator 15 to which the root mean square value forming device is connected. The threshold value comparator 15 comprises two further inputs, each of which can be supplied with an upper and a lower threshold value signal.

The comparator 15 provides an ASK indicator signal, an FSK indicator signal or a noise indicator signal at respective outputs depending on whether the filtered and averaged RSSI signal is between the upper and lower thresholds, is above the upper threshold or is below the lower threshold, respectively. The control logic unit 9 drives the demodulator 6 depending on whether an amplitude-modulated, a frequency-modulated or no useful signal at all is detected.

In accordance with the present invention, the root mean square value of the RSSI signal without a DC component is used to distinguish between whether an amplitude-modulated or a non-amplitude-modulated signal is present. Only the alternating component of the received field strength signal is thus used to evaluate whether an amplitude-modulated or a frequency-modulated/phase-modulated signal is received.

For the first situation in which no modulated useful signal at all is received at the antenna 1, the signal component which is used for the purpose of determination has a value which is determined by the system and the noise characteristics. If an amplitude-modulated signal is received, the rectified alternating component of the RSSI signal increases, since the signal energy increases as a result of the fluctuation in amplitude. However, in the case of a signal of constant amplitude, that is to say a signal having a constant envelope, as in the case of pure frequency or phase modulation, the root mean square value or mean value becomes smaller and tends toward zero for higher field strengths. The noise level continues to decrease very rapidly in this manner as the received signal level increases, since the limiter effect rapidly eliminates the noise. It is thus possible to assess the signal's type of modulation close to the sensitivity threshold of the receiver.

It is possible to distinguish between a total of three situations using appropriate threshold values at the comparator 15: If, in the first situation, the root mean square value measured is between the upper and lower thresholds, no useful signal is received. If the root mean square value is above the upper threshold, an amplitude-modulated signal, for example amplitude shift keying, is involved. However, if the root mean square value is less than the lower threshold, a signal having a constant envelope, for example a frequency-shift-keyed signal, is injected at the antenna.

Accordingly, the present invention allows a statement to be made not only regarding whether an amplitude-modulated or a frequency-modulated signal is present but also, moreover, regarding whether a signal is detected at all in the reception channel.

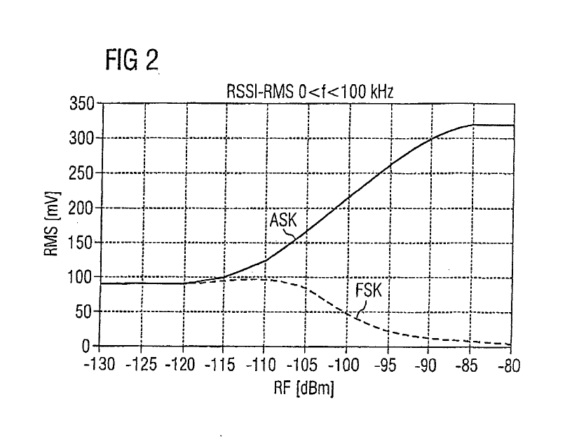

FIG. 2 shows a graph in linear-logarithmic form, in which the root mean square value of the alternating component of the RSSI signal (in millivolts) is plotted against the received field strength of the radio-frequency signal (measured in dBmW). In this case, frequencies of between 0 and 100 kHz were taken into account. It can clearly be seen that, even from low received field strengths of approximately −115 dBm, it is possible to distinguish between whether an amplitude-shift-keyed or a frequency-shift-keyed signal (denoted ASK and FSK, respectively, in the present case) is present. As the received field strength or input power increases, the distinction becomes more and more simple.

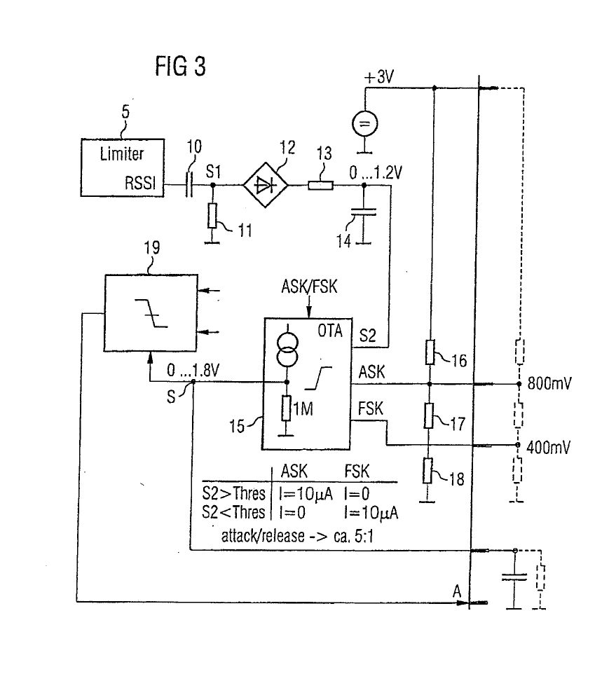

FIG. 3 uses a circuit diagram to show one exemplary design of the identification unit 8, the latter having a high-pass filter 10, 11, which is connected to the RSSI output of the limiter 5, a downstream root mean square value forming device 12, 13, 14, which comprises a diode 12, a series resistor 13 and a capacitance 14 that is connected to ground, and a comparator 15 which is in the form of a transimpedance amplifier and has two threshold value inputs.

The comparator comprises an ASK threshold value input and an FSK threshold value input which are connected to a voltage divider which comprises three series resistors 16, 17, 18 and is connected between a supply potential of plus 3 V and reference-ground potential. The resistances of the resistors 16 to 18 are selected in such a manner that a potential of 800 mV is produced at the ASK threshold value input, but a potential of 400 mV is produced at the FSK input. The transimpedance amplifier 15 comprises a controlled current source which emits a current depending on whether the alternating components of the averaged RSSI signal are above the upper threshold or are below the lower threshold. The output signal at the output of the comparator 15 can accordingly be used to determine whether a useful signal is detected at all. The fact of whether the signal is an amplitude-modulated or a frequency-modulated signal can likewise be read from the output signal from the transimpedance amplifier 15.

In the example shown in FIG. 3, in addition to the operation of driving the control unit 9 (already explained), which in turn drives the demodulator 6, a so-called data slicer is additionally driven in the present case depending on whether an amplitude-modulated or a frequency-modulated signal is detected. In the signal processing chain shown in FIG. 1, this data slicer 19 is connected to the output of the data filter 7 but is not shown there.

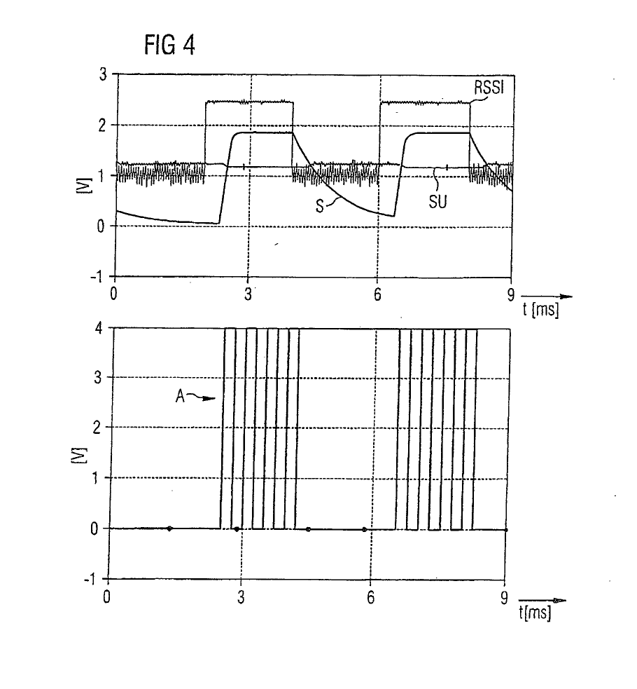

FIG. 4 uses one exemplary embodiment of the present invention to show the simulation results when a frequency-shift-keyed signal is present in accordance with the circuit diagram shown in FIG. 3. In this case, the signal voltage is plotted against time (in milliseconds). The upper part of the graph shows the profile of the RSSI signal RSSI, the relatively constant profile of the corresponding lower threshold SU of the comparator 15 and the signal profile of the output signal S from the comparator. If the output signal S from the comparator is above the threshold SU, the output of the received signal processing chain is enabled, and a corresponding demodulated output signal A is output (see the lower half of the figure).

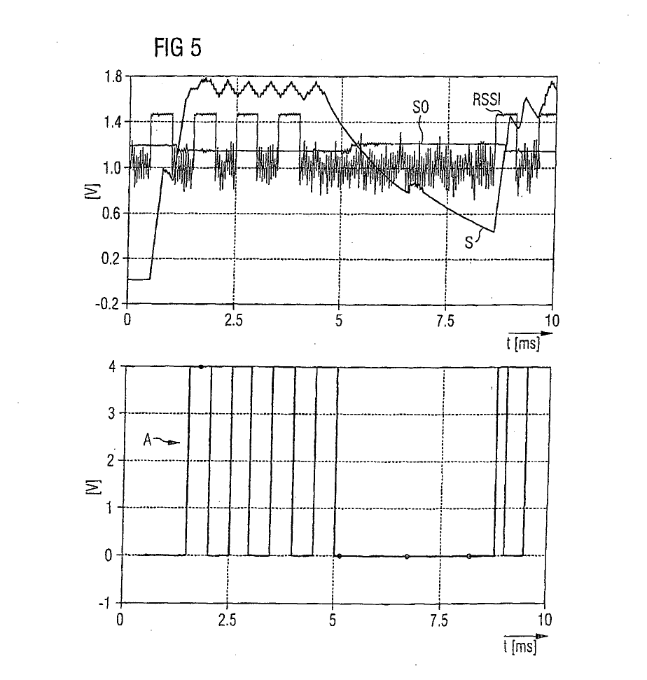

FIG. 5 likewise uses graphs to show the profile of the characteristic signals shown in FIG. 3 using an example of an amplitude-shift-keyed signal. The profiles of the RSSI signal, the signal threshold SO, the output signal S and the output signal A from the received signal chain are also clearly shown here.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A receiving arrangement for a radio signal, comprising:
a step-down frequency converter comprising a first input for receiving the radio signal, a second input for receiving a local oscillator signal, and an output, wherein the step-down frequency converter is configured to generate and provide an intermediate frequency level signal at the output based on the radio signal and the local oscillator signal;
an amplifier comprising an amplifier input, which is coupled to the output of the step-down frequency converter, and an amplifier output, wherein the amplifier is configured to generate and emit a received field strength signal at an output thereof;
a demodulator configured to demodulate the radio signal from the amplifier which has been down-mixed and amplified, the demodulator comprising a signal input, which is coupled to an output of the amplifier, a signal output for emitting the demodulated radio signal, and a control input, wherein the demodulator is further configured to select and perform one demodulation method from a number of predetermined demodulation methods based on the the control signal at the control input thereof; and
an identification unit comprising a high-pass filter having an input coupled to the output of the amplifier and configured to receive the received field strength signal thereat, and further comprising a threshold value comparator circuit having an input coupled to the output of the high-pass filter and having an output coupled to the control input of the demodulator, wherein the identification unit is configured to emit a value to the demodulator that represents the modulation method employed to modulate the radio signal, and further comprising a means for forming a mean value or a root mean square value of the received field strength signal, the means coupled between the high-pass filter and the threshold value comparator.

2. The receiving arrangement of claim 1, wherein the threshold value comparator comprises a threshold value input for supplying a signal threshold comprising a value between a value range for the filtered received field strength signal that characterizes an amplitude-modulated signal, and a value range for the filtered received field strength signal that characterizes a frequency-modulated signal.

3. The receiving arrangement of claim 2, wherein the threshold value comparator comprises a further threshold value input, wherein the value of the received field strength signal representing the radio signal's modulation method resides within one of three predetermined states which are included in the following set: no signal, an amplitude-modulated signal, and a frequency-modulated signal.

4. The receiving arrangement of claim 1, further comprising a control unit configured to couple the threshold value comparator to the control input of the demodulator in order to select the demodulation method from a number of predetermined demodulation methods as a function of the value of the received field strength signal.

5. The receiving arrangement of claim 1, wherein the identification unit further comprises a signal processing block comprising a control input coupled to the output of the threshold value comparator circuit, and comprising an output coupled to the demodulator.

6. The receiving arrangement of claim 1, wherein the step-down frequency converter is coupled to the amplifier via an intermediate frequency filter.

7. The receiving arrangement of claim 1, wherein the high-pass filter in the identification unit comprises a series capacitance with a downstream resistor connected to ground.

8. The receiving arrangement of claim 1, wherein the amplifier having the output that emits the received field strength signal comprises a limiting amplifier.

9. A radio signal receiver, comprising:
a mixer configured to receive a radio frequency signal and output an intermediate frequency signal associated therewith;
an amplifier configured to receive the intermediate frequency signal and output an amplified version of the intermediate frequency signal and a received field strength signal associated therewith;
an identification unit configured to receive the received field strength signal and generate a control signal associated therewith; and
a demodulator configured to receive the amplified intermediate frequency signal and the control signal and perform one of a plurality of available demodulation functions on the amplified intermediate frequency signal based on the control signal.

10. The receiver of claim 9, wherein the identification unit comprises a calculation circuit configured to receive the received field strength signal and output a mean value or a root mean square value of the received field strength signal, wherein the control signal is a function of the value thereof.

11. The receiver of claim 10, wherein the identification unit further comprises a comparator circuit configured to receive the mean value or the root mean square value, compare the value to one or more predetermined thresholds, and generate the control signal in response thereto.

12. The receiver of claim 11, wherein the comparator circuit is configured to output the control signal indicative of an amplitude related modulation when the mean value or root mean square value exceeds a first threshold, and output the control signal indicative of a frequency related modulation when the mean value or root mean square value is below a second threshold, wherein the first threshold is greater than the second threshold.

13. The receiver of claim 9, wherein a gain of the amplifier is 1.

14. A method of receiving a radio frequency signal, comprising:
converting the radio frequency signal to an intermediate frequency signal;
generating a received field strength signal based on the intermediate frequency signal; and
determining a type of modulation used to modulate the radio frequency signal based on the received field strength signal.

15. The method of claim 14, further comprising demodulating the intermediate frequency signal using one of a plurality of available demodulation methods based on the determined modulation type.

16. The method of claim 14, wherein determining the modulation type comprises:
generating a mean value or a root mean square value of the received field strength signal; and
determining the modulation type based on the generated mean value of root mean square value of the received field strength signal.

17. The method of claim 16, wherein determining the modulation type further comprises:
comparing the mean value or the root mean square value of the received field strength signal to one or more predetermined thresholds; and
determining the modulation type based on a result of the comparison.

18. The method of claim 17, wherein comparing comprises:
comparing the mean value or the root mean square value of the received field strength signal to a first threshold; and
comparing the mean value or the root mean square value of the received field strength signal to a second threshold that is a value less than the first threshold.

19. The method of claim 18, wherein determining the modulation type comprises:
determining that the radio frequency signal is modulated with an amplitude related type of modulation if the mean value or the root mean square value of the received field strength signal is greater than the first threshold; and
determining that the radio frequency signal is modulated with a frequency related type of modulation if the mean value or the root mean square value of the received field strength signal is less than the second threshold
